(19) United States
(12) Patent Application Publication
(10) Pub. No.: US 2012/0095999 A1
(43) Pub. Date: Apr. 19, 2012

(54) SYSTEM AND METHOD FOR IDENTIFYING A STORED RESPONSE TO A SUBJECT QUERY

(76) Inventors: Maxim Donde, Netania (IL); Yoav Gelbfish, Tel Aviv (IL)

(21) Appl. No.: 13/273,355

(22) Filed: Oct. 14, 2011

Related U.S. Application Data
(60) Provisional application No. 61/393,508, filed on Oct. 15, 2010.

(51) Int. Cl. G06F 17/30

(52) U.S. Cl. 707/728; 707/E17.084

(57) ABSTRACT

A system and method of identifying stored responses that may be relevant to a subject query, by identifying relevant phrases in the query that express a topic of the query. A list of the relevant phrases is indexed, and a set of stored responses is reviewed to find a response that includes one or more of the relevant phrases. Relevant phrases may be ranked so that matches of particular phrases in a subject query and stored response may be given more weight in determining a relevance of a stored response. Stored responses may be ranked by the relevance of the terms that they include, where such terms are also relevant to the subject query.

### CROSS REFERENCE TO RELATED APPLICATIONS

This application claims priority of U.S. Provisional Application No. 61/393,508, filed Oct. 15, 2010, the entire disclosure of which is incorporated herein by reference.

### FIELD OF THE INVENTION

The present invention generally relates to searching tools, and more particularly, to searching for stored texts to assist customer support personnel in responding to a current query.

BACKGROUND OF THE INVENTION

Customer service, help desk or other trained personnel receive written or telephonic requests for assistance from customers. Telephonic requests are often transcribed on pre-prepared forms into brief written queries. The trained personnel rely on manuals or written formulations to prepare answers or provide assistance to the queries. Many of the queries are repeat queries, such that the same question has been posed before by a customer and answered by a particular member of the trained personnel, yet other members of the staff may be forced to find a response to the query in the manual or other written formulations.

### SUMMARY OF THE INVENTION

### Brief Description of the Drawings

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a conceptual illustration of a system in accordance with an embodiment the invention;

FIG. 2 is a diagram of selected phrases in a subject query and in two stored queries showing relations and ranking of relevant phrases in the subject query to stored phrases in the stored responses;

FIG. 3 is relevance table for terms found in the subject query and in the stored responses, in accordance with an embodiment of the invention; and

FIG. 4 is a flow diagram in accordance with an embodiment of the invention.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

An embodiment of the invention may be practiced through the execution of instructions that may be stored on an article such as a disc, memory device or other mass data storage article. Such instructions may be for example loaded into a processor and executed. In some embodiments, a processor may search an electronic data base of phrases that may be identical to, similar to or otherwise more distantly related to a particular relevant phrase. A processor may expand a search of a data base to identify other stored phrases that are similar to a first stored phrase that is similar to a relevant phrase in a subject query.

When used in this paper, and in addition to its regular meaning, the term ‘subject query’ or ‘current query’ may refer to a question, inquiry, topic, discussion point or item to be researched that is a focus of a request or search for related stored information. For example, a subject query could be a request from a customer to a customer service center for software installation or trouble shooting information on a version of software. A subject query may also include a trouble-shooting inquiry from a driver to an auto manufacturer relating to a noise coming from an engine. A subject query could be a physical complaint from a patient directed to a doctor or health practitioner or health data base. The subject query may be or include the subject, topic or question that may be addressed, discussed or included in a stored document or other information source that is stored in an electronic storage medium regardless of the knowledge domain (such as for example computers, automotive, electronics, etc.) or field of the current query or stored document.

In some embodiments, a subject query may be presented in a designated or pre-defined form. For example, a subject query that may have arrived as an email from a field representative may include a subject line, a date or place where the product was purchased, a configuration of the product and a free-text description of the problem. Other formats, such as a product return confirmation may include a greater number of fields and less free text. In some embodiments, no particular format or structure of the stored response may be necessary, and a search or comparison of one or more terms, phrases or tokens in a query may be made to one or more documents that include primarily or exclusively free-text.

When used in this paper, and in addition to its regular meaning, the term ‘stored response’ may include an electronically stored version of an answer, response or resolution to a query that had been addressed in the past. The stored response may also include the query that had been the cause for the preparation of the stored response. For example, a stored response may include the text of suggested cream to address a complaint of peeling skin on the bottom of a large toe, as well as the original query posed that includes the description of the peeling skin on the toe. A stored response may also refer to any stored document or text, and need not be limited to an actual response that was provided in respect of a query. A stored response may be an article, story, physical description, biography, recipe, diagnosis or other collection of words or phrases in a relevant knowledge domain. For example, a stored response may refer to a decision or opinion of a court, a financial report, a stock analysis, a review of a book, a newspaper article, a text book or a research paper. In some embodiments, a stored response may include a past response or instruction provided to a customer by a customer service representative who may have diagnosed a technical problem and then recommended and documented a particular solution.

When used in this paper, and in addition to its regular meaning, the term relevance of a phrase or term may mean or include the extent to which a word, term, group of words, clause, symbol or technical designation is relevant to the formulation of a question, point or issue being posed in a subject query. For example, the term ‘Error Message #304’ may be considered to have high relevance for addressing a customer inquiry about software, while the clause ‘Hi, I was wondering’ may be considered to have a low relevance to inquiries about software.

Relevance may be created or inferred from a presence of term or phrase in a dictionary or other compendium of terms used in a knowledge domain. For example, a dictionary of a domain such as cooking terms may include the word ‘butter’ and the word ‘render’, and the appearance of both of such words in a technical compendium in a particular knowledge domain may be used as an indication of heightened relevance or association of the two words. If a subject query includes butter, the appearance in a stored response of both butter and render which are both listed in a cooking dictionary, may be used to as an indicator of relevance to the term render in a question or query posed in a cooking domain. Such a dictionary or compendium may be created for one or more knowledge domains and may include relations among for example synonyms or other relations between terms. A term or phrase may also be related to itself and to various conjugations or variations of itself.

When used in this paper, and in addition to its regular meaning, the term ‘token’ may refer to a word, phrase, clause, symbol or other designation that had been found in either a stored response, in a subject query or in a list of terms, that may be deemed as a relevant phrase, and for which one or more associations may exist to other relevant phrases. For example, the term ‘browser’ may be included in a list or compilation of computer software domain terms, along with a list of associated terms or phrases and a relative strength of such association to other terms or tokens. For example, the token ‘browser’ may be stored along with an association or other relevance marker and a ranking such as a 10 to another token such as Windows™ Internet Explorer™ and to Chrome™. A lower relevance ranking may for example be assigned to a token such Explorer 6, since the appearance of specific version of Explorer may be indicative of relevance to a particular version rather than to browsers generally. The token Browser may have an even lower relevance to certain conjugations or permutations of the term such as browse and browsed, even though they may be stems of browser, since these stems would be verbs rather than the noun which refers to a browser software product. The terms ‘browse’ and browsed might, however, have strong relevance ranking to the words search and find.

In some embodiments, a length of a term or token may be used as an indicator of enhanced or elevated relevance. For example, the term ‘butter the bread’ may be deemed a token in a knowledge domain for cooking, and a stored response that includes this token may be deemed to be highly relevant, given the length or specificity of the token.

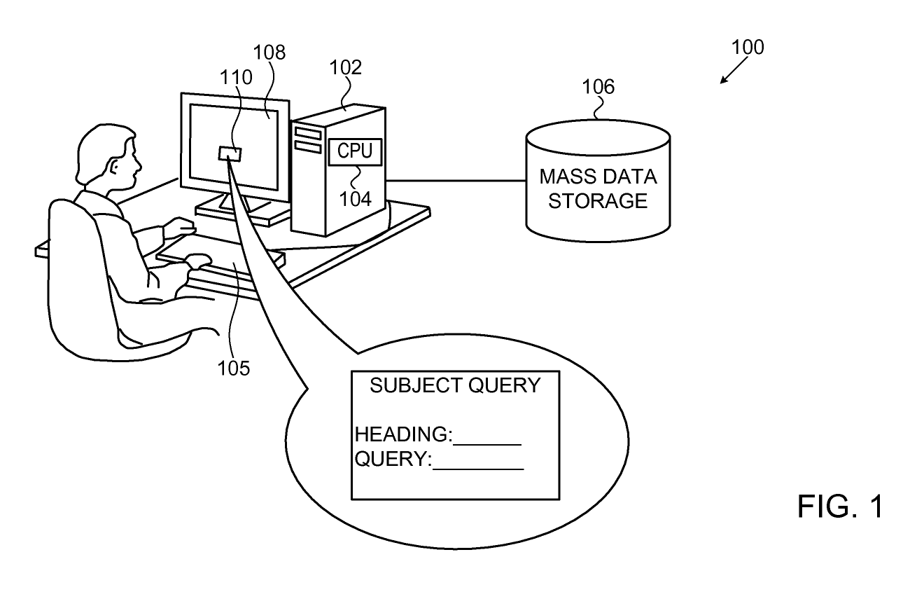

Reference is made to FIG. 1, a conceptual illustration of a system in accordance with an embodiment of the invention. In some embodiments, system 100 a computer 102 or other electronic device that may have, include or be connected to a processor 104 that may be suitable for executing software instructions such as searches. Computer 102 may include an input device such as a keyboard 105, scanner, mouse or other device by which instructions may be issued to the processor 104. Computer 102 may be linked to a network such as a telephone network, LAN, WAN or Internet that may be suitable for receiving and displaying or otherwise presenting to a user of system 100, on for example a screen 108, a text or recording of a subject query 110 that may be transmitted to the user. Computer 102 may include or be connected to a mass data storage system such as for example memory 106 having a data base or other structured data storage medium.

In some embodiments, there may be stored on memory 106, one or more collections of token, phrases, terms, words, clauses, symbols or other designations. Such phrases may be designated or associated with each other in various ways. For example, certain stored phrases may be included in a list of technical terms relating to a field or category or products or services. For example, the terms or phrases engine, tire, windshield and headlight may be associated as belonging to a car domain. Another list or collection that may be stored for example in an electronic data base, such as a subset of the above list, may include part-numbers or serial numbers that are related to or relevant for a particular make, model or year of car or to an error or malfunction type of a particular car. Some of such lists or collections may be derived from a general dictionary, from a technical dictionary—such as an anatomy textbook, for a particular field or category of a part or service, or from a specific producer of cars, drugs, parts or other equipment. Memory 106 may designate one more of the stored phrases as originating from a general source such as a dictionary, or from a particular source such as a producer's parts list. One or more of the phrases stored on memory 106 may also be associated with one or more other such stored phrases. For example, a term ‘engine’ may be associated with a term ‘motor’ and such association may be deemed to be an identical, synonymous or very strong association. A term ‘tire’ may be associated with a term ‘wheel’ and such association may be deemed to be of a moderately similar nature. A term ‘hub’ may be associated with the term ‘wheel’, such that ‘tire’ and ‘hub’ may have be deemed to have a secondary or iterative association. In some embodiments, a collection of phrases or terms may include abbreviations, slang, short-names, nicknames, or other commonly-used, though unofficial designations by which a product, service or part is referred. In some embodiments, and in this application, technical terms or terms relating to a field, product, service or part may be referred to as domain terms.

General terms, phrases or clauses that may be included in a free-text query presented by a user may also be stored. For example, ‘broken’, ‘crashed’, ‘dead’, ‘start’, ‘blink’ and other verbs, nouns and vernacular phrases may be stored. Similarly, stems, roots, abbreviations, conjugations and slang may be associated with formal or extended versions of the phrases so that a term like ‘broken’ and its stem ‘broke’ or ‘break’ may be deemed equivalent. In some embodiments, and in this application, general terms such as dictionary terms, verbs and free text words may be referred to as Meaningful Words.

Memory 106 may include a collection of stored responses, and a list of the one or more phrases and tokens that are included in such stored responses. Memory 106 may also include a list of associations of one or more stored responses with one or more other stored responses that have in the past been found to be relevant to or helpful in explaining the topic or solution presented by the stored response. In some embodiments, a system may create or increase a relevance of a token to one or more other tokens that have been found in past queries to be relevant or included in a stored response that was selected as a match to a subject query. The system may thereby learn or dynamically infer relevance from past searches so that relations between tokens may be updated with results of past searches. Similarly, stored responses that include such tokens may be deemed more relevant or ranked with higher relevance to subject queries that include the token or are otherwise related to the token.

In operation, a user may present a subject query on for example a form. In some embodiments of the invention, system 100 may analyze one or more of the fields and the free-text in the subject query, to find a list of tokens such as domain terms and meaningful words that may be included in the subject query. The developed token list for the subject query may be compared to the token lists that are associated with stored responses. The extent of the similarity between a token list of a subject query and a token list of a stored response, may be used as a determinant of the similarity between the subject query and the subject response.

In some embodiments, the topic, theme or relevance of a stored response or other stored document to a particular field need not be input or manually prepared. Such relevance may be derived from one or more of the presence, frequency, position or other criteria of the tokens that appear in the stored document.

In some embodiments, a ranking may be applied to a comparison of one or more tokens that are found in a subject query and in a stored response. For example, a token that is found in a list of domain terms and that are specifically identifiable with a product, part or distinct characteristic of a product or part, may be assigned a relatively high relevance value so that a matching token that is found in a stored response will have strong influence on a ranking calculation of such stored response. Similarly, a direct or identical match between one or more tokens found in a subject query and found in a stored response may add to the relevance ranking between the subject query and the stored response.

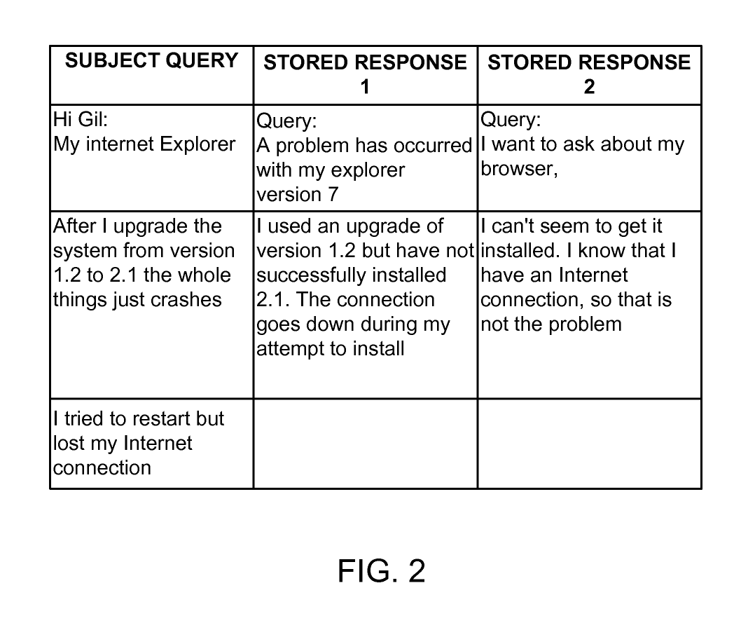

Reference is made to FIG. 2 a sample of a subject query and two stored responses, in accordance with an embodiment of the invention. In the figure a subject query includes a series of words. The words are parsed by the processor to find domain terms which are also tokens and to find meaningful terms that are tokens. domain terms and meaningful words may be expanded to include synonyms, related terms and terms related to synonyms. For example, the token ‘crash’ found in the subject query may be expanded to include ‘goes down’ and ‘problem’.

A list of the found tokens, as was expanded for the subject query may be developed into an index and the index may be searched on a data base of stored terms.

A search may also be made of a memory to find stored responses that contain one or more of the tokens that were identified in the expanded list of tokens of the subject query. A weighting or relevance boosting factor may be added to certain of the tokens such as those that are domain terms, with product specific references, such as Internet Explorer, version 1.2 and 2.1. A relevance boosting factor may also be added to a direct match of meaningful words, while a lower boosting factor may be added for a match to a synonym of a meaningful word such as ‘crash’ and ‘problem”.

System 100 may search memory 106 for stored responses that include one or more of the domain terms or meaningful words on the list of expanded tokens. A calculation of the number of matches and the boost factors of such matches may be made between the expanded list of the tokens in the subject query and the tokens in each of some of the stored responses that included the expanded token list as are stored in the memory. The stored responses that are most highly ranked may be presented to a user in for example an order of their derived ranking of their relevance to the subject query.

In some embodiments, a boost factor or relative strength of a match, may be given more weight to a match of a long sequence of words in a phrase than a single matching word in a phrase or token. For example ‘beat the egg whites’ may be used as a token, and would be given high relevance to a match of such a long token. Lower relevance may be assigned a word used frequently in many stored responses (such as ‘PC’ ‘computer’ or to certain abbreviations or salutations such as LOL). Similarly, queries in a knowledge domain covering software produced by for example Oracle™ may disregard the term Oracle, since queries will frequently use that term generically, making the term unhelpful for determining relevance.

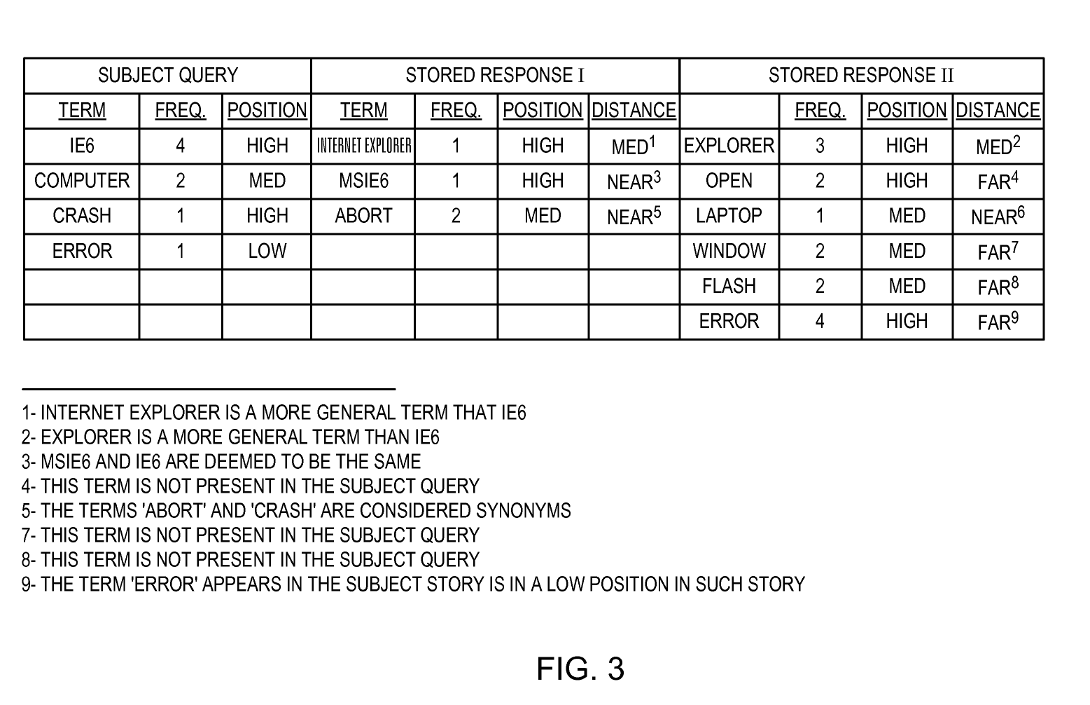

Reference is made to FIG. 3, a relevance table in accordance with an embodiment of the invention. In FIG. 3, a list of tokens found in a subject query may be assembled and loaded for example into a first column of a relevance table. A relevance ranking of one or more of such tokens to the subject query may be calculated based on for example a position (subject line, title, first paragraph, etc.) of the token in the subject query, a frequency of the use of the token in the subject query. In the example presented in FIG. 3B, the token IE6 may be used several times in the full text of the subject query and may appear once in a heading of the query which means that its position is one of high relevance to the subject query. The token ‘crashed’ is found to appear once in the subject query and to appear in a position of high relevance in the subject query.

The tokens in the subject query may be expanded to include related tokens that may be stored in for example a domain term dictionary, and the relationship of the token in the subject query to the expanded list of tokens may be retrieved. The process may be further expanded to find tokens that are related to the tokens that were related to the tokens in the subject query.

A search of stored queries may be performed, and a first such stored query may be found to include the term Internet Explorer used one time in a position of High relevance. A comparison of the term Internet Explorer 6 from the subject query to Internet Explorer in the first stored query may conclude that the distance or similarity of the two terms is Medium since IE6is a more specific term than Internet Explorer. The first stored query may use the token ‘abort’ twice in positions of medium importance, but the term abort may be deemed a synonym or very similar to the term crash in the subject query.

A second stored query may use the term ‘Explorer’ three times in at least one position of high frequency, and the term Explorer may be deemed medium distance from IE6 as was found in the subject query. The term laptop may be deemed to be a synonym to the term computer found in the subject query and may in any case be deemed generic and therefor excluded from the token list.

A process of evaluating relevance of the tokens in a stored query to the stored query itself and a similarity or distance of such tokens to tokens in the subject query may proceed until some or all of the tokens in the stored queries are evaluated for their relevance to the stored response. The similarity of the tokens in the stored response may be evaluated relative to the relevant tokens in the subject query. The stored queries with the highest rankings may be selected and displayed to a user who posed the subject query or to another user.

In some embodiments, a ranking of a stored query as helpful for a subject query may be calculated for tokens Ti through Tn in a subject query as follows:

Ranking=(Similarity of Ti to Ti′)(relevance of Ti to subject query)(relevance of Ti′ to stored query), where Ti′ are tokens found in the stored query that are identified as similar to Ti in a subject query.

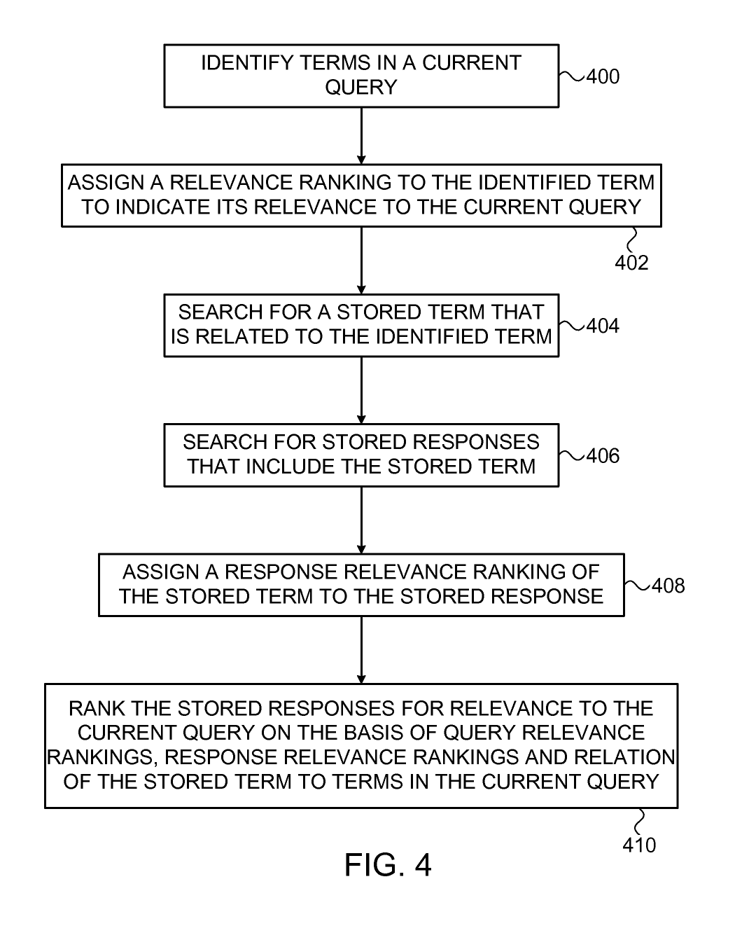

Reference is made to FIG. 4, a flow diagram in accordance with an embodiment of the invention. A method in accordance with an embodiment of the invention may identify a relevance of a stored response relevant to a current query. In block 400, there may be identified in a current or subject query, certain terms, such as tokens or other meaningful terms. In block 402, a relevance ranking may be assigned to one or more of the identified meaningful terms, and such relevance ranking may indicate a relevance of the respective term to the current or subject query. In block 404, a data base of stored terms may be searched to find or identify a stored term that is related to one of the identified meaningful terms in the current query. In block 406, a search may be performed of several stored responses that may be stored in an electronic data base, to find one or more responses that include the stored term. In block 408, a response relevance ranking may be assigned to rank the relevance of the stored term to each of the one or more of the identified stored responses. In block 410, the stored responses that include the stored terms may be ranked for relevance to the current query on the basis of the relevance rankings of the identified term to the current query, the relevance ranking of the stored term to the stored response and the closeness of the relation of the stored term to the identified term in the current query.

In some embodiments, identifying a term in the current query may include identifying a technical phrase in the current query as relevant to the current query, and identifying a lexical phrase in the current query as relevant to the current query.

In some embodiments, assigning a query relevance ranking may include assigning a query relevance ranking to a term in the current query on the basis of a position of that term in the current query.

In some embodiments, identifying a stored term may include searching an electronic data base of stored terms for a synonym or other match to an identified term in the current query.

In some embodiments a ranking of stored responses may include assigning a first value to a first stored response on the basis of a presence in the first stored response of a term that is also present in the current query, assigning a second value to the stored response on the basis of a presence in the stored response of a synonym of the term in the current query, and assigning a third value to the stored responses on the basis of a presence in the stored response of a stored term that is merely similar to the identified term in the current query.

In some embodiments, assigning a query relevance ranking may include assigning a value to a term in the current query on the basis of a presence of such term in a list in an electronic data base of stored terms that relate to a product, assigning a second value to a term in the current query on the basis of a presence of the term in an electronic data base of stored phrases relating to a category of products that includes such product, and assigning a third value to the term on the basis of a presence of term in an electronic data base of other stored terms such as a dictionary or other general compilation.

In some embodiments, assigning a relevance ranking of a term to a current query may include counting a number of times that the term appears in the current query.

In some embodiments, identification of terms in a current query may entail excluding terms that are generic to a domain to the current query. For example, a current query that is in a domain of computers, may exclude a term such as PC, since such term may be overly generic to constitute a meaningful basis upon which to find a related stored response.

In some embodiments, a relevance of a stored term to a stored response may be increased if a signal is received from a prior query the particular stored response was found to be relevant to a query that includes the stored term.

In some embodiments a relevance ranking of a term may be increased on the basis of a number of words in the term

In some embodiments, identifying a stored responses may include searching responses to queries posed to a customer service center.

It will be appreciated by persons skilled in the art that embodiments of the invention are not limited by what has been particularly shown and described hereinabove. Rather the scope of at least one embodiment of the invention is defined by the claims below.

We claim:

1. A method of identifying a stored response relevant to a current query, comprising:
identifying a plurality of terms in a current query;
assigning a plurality of respective query relevance rankings for each of said plurality of terms in said current query;
identifying a stored term related to one of said plurality of terms in said current query;
identifying a plurality of stored responses in an electronic data base, said stored responses including said stored term;
assigning a plurality of respective response relevance rankings for a relevance of said stored term to each of said plurality of stored responses; and
ranking said plurality of stored responses by
said query relevance rankings;
said response relevance rankings; and
said relation of said stored term to one of said plurality of terms in said current query.

2. The method as in claim 1, wherein said identifying a plurality of terms in said current query comprises identifying a technical phrase in said current query as relevant to said current query; and identifying a lexical phrase in said current query as relevant to said current query.

3. The method as in claim 1, wherein said assigning said plurality of respective query relevance rankings comprises assigning a respective query relevance ranking to a first term in said current query on the basis of a position of said first term in said current query.

4. The method as in claim 1, wherein said identifying said stored term comprises searching an electronic data base of stored terms for a synonym of a first of said plurality of terms in said current query.

5. The method as in claim 1, wherein said ranking said plurality of stored responses comprises assigning a first value to a first of said plurality of stored responses on the basis of a presence in said first stored response of a first of said plurality of terms of said current query, a second value to said first of said plurality of stored responses on the basis of a presence in said stored response of a synonym of said first of said plurality of terms in said current query, and a third value to said first of said plurality of stored responses on the basis of a presence in said stored response of a stored term similar to said first of plurality of terms in said current query.

6. The method as in claim 1, wherein said assigning said plurality of respective query relevance rankings comprises assigning a first value to a first of said plurality of terms in said current query on the basis of a presence of said first of said plurality of terms in said current query in said electronic data base of stored terms relating to a product, assigning a second value to said first of said plurality of terms in said current query on the basis of a presence of said first of said plurality of terms in said current query in an electronic data base of stored phrases relating to a category of said products, and assigning a third value to said first of said plurality of terms in said current query on the basis of a presence of said first of said plurality of terms in said current query in an electronic data base of other stored terms.

7. The method as in claim 1, wherein said assigning said respective query relevance rankings comprises counting a number of times a first of said plurality of terms in said current query appears in said current query.

8. The method as in claim 1, wherein said identifying said plurality of terms in a current query comprises excluding from said plurality of terms in said current query a term that is generic to a domain of said current query.

9. The method as in claim 1, comprising, increasing a first of said plurality of respective response relevance rankings upon receipt of a signal that a first of said stored responses that includes said stored term is relevant to said current query.

10. The method as in claim 1, comprising increasing a query relevance ranking of a first of said plurality of terms in said current query on the basis of a number of words in said first of said plurality of terms in said current query.

11. The method as in claim 1, wherein said identifying a plurality of stored responses comprises, searching a plurality of responses to queries posed to a customer service center.

12. The method as in claim A, wherein said identifying a stored term related to one of said plurality of terms in said current query, comprises identifying a stored term related to said term related to said term in said current query.

13. A system to identify a stored response that is relevant to a current query, said system comprising:
a mass data storage device to store:
a plurality of terms, and a relation of a first of said plurality of terms to
a second of said plurality of terms, and
a collection of stored responses;
a processor to
identify a plurality of terms in a current query;
assign a plurality of respective query relevance rankings for each of said plurality of terms in said current query;
identify a stored term in said plurality of terms stored on said mass storage device, that are related to one of said plurality of terms in said current query;
identify a plurality of stored responses stored on said mass storage device, said stored responses including said stored term;
assign a plurality of respective response relevance rankings for a relevance of said stored term to each of said plurality of stored responses; and
rank said plurality of stored responses by
said query relevance rankings;
said response relevance rankings; and
said relation of said stored term to one of said plurality of terms in said current query.

14. The system as in claim 13, wherein said processor is to increase a query relevance ranking of a first of said plurality of terms in said current query on the basis of a number of words in said first of said plurality of terms in said current query.
